(19) United States
(12) Patent Application Publication
(10) Pub. No.: US 2012/0098335 A1
(43) Pub. Date: Apr. 26, 2012

(54) ENERGY SUPPLY IN AN ELECTRIC NETWORK

(75) Inventors: Johann Hell, Laaben (AT); Nebojsa Danilovic, Wien (AT)

(73) Assignee: Andritz Hydro GmbH, Wien (AT)

(21) Appl. No.: 13/263,872

(22) PCT Filed: Mar. 12, 2010
(86) PCT No.: PCT/AT2010/000077

§ 371 Date: Dec. 27, 2011

(30) Foreign Application Priority Data
Apr. 10, 2009 (AT) A 570/2009

(51) Int. Cl. H02J 4/00

(52) U.S. Cl. 307/18

(57) ABSTRACT

The invention relates to a device and a method that can enable generators for producing electrical energy to be kept stable on the network during and following a line failure, such as a voltage dip. This requirement is defined in the network connection conditions of many network operators and must be observed for installations of a certain power. According to the invention, during a line failure, a load is inserted, enabling the energy that can no longer be supplied to the electric network due to the voltage drop to be absorbed by the load.

The subject of the present invention is a process for supplying energy to a grid, in which energy in the form of electric current is generated by at least one generator and supplied to a grid, where the generator is either connected directly or via a transformer to a point of common coupling.

The subject of the present invention is also a device with which to perform the process according to the invention.

The present invention enables generators for producing electrical energy to withstand a voltage dip without becoming unstable.

The need to shunt out (span) brief grid faults can be found in all specific grid connection conditions of transmission system operators. However, the values and the duration of the undervoltage can vary substantially.

The problem in the event of a massive drop in voltage (voltage dip) is that the energy provided by the primary generating unit cannot be transferred to the grid to the necessary extent due to the reduced voltage. This causes the generator rotor to accelerate, and if the grid fault lasts too long, there is a risk of the relative rotor position deviating so far from its initial position that it is not possible to revert to stable operation again when the fault has been eliminated.

In order to maintain stable grid operation in spite of this, the transmission system operators are demanding from power plant operators that the plants installed must be capable of withstanding voltage dips for a limited period without a fault occurring (=low voltage ride-through capability—LVRT). This demand is usually also linked to a certain power and voltage level at the point of common coupling to the grid. That means that this demand usually has no relevance for smaller generating units. However, the definition of LVRT is based on the total of the units installed. The point of this is that the total of the small units is considered as one large unit (particularly in wind parks). The reason for this is that it is preferred to switch off as little generating power as possible when there is a grid fault in order to ensure that the grid is established again properly afterwards. If this were not the case, the voltage could collapse or the transmission lines could suffer overloading.

This problem of possible instability in the event of a brief grid fault occurs more frequently in uncontrolled units. Examples of this are permanent magnet generators and/or hydraulic turbines without control equipment. Furthermore, the problem is intensified when the generating units have rotors with a low mass moment of inertia.

The invention describes a simple and robust concept that can be applied for one or also several power generating units (generators) arranged in parallel.

The invention is limited to generators for producing electric power that are connected directly to the grid or via one or more transformers. If a grid fault occurs, the generator(s) remain(s) connected to the grid.

The process according to the invention is now based on a load, which is shunted out by a switch in normal operation, being inserted by opening the switch in the event of a voltage drop (voltage dip) in the grid, with the result that at least part of the electrical energy that can no longer be supplied to the grid due to the reduced voltage is absorbed by the load. Acceleration of the rotor is thus prevented and the generator remains within a stable operating range.

When the grid has reached a voltage corresponding to normal operation after the voltage dip, the switch is then preferably closed again so that the load is shunted out again. The grid voltage is then at its set value again, and the kinetic energy supplied to the generator can thus be supplied to the grid again in the form of electrical energy without any difficulties. Thus, there is no longer any need for energy absorption by the load.

This invention is well suited for special generators with permanent magnet excitation, because these generators have rotors with a comparatively low mass moment of inertia and are thus particularly susceptible to rotor acceleration as a result of dips in voltage. The demand for fault-free shunting out of voltage dips can then also be met for these generators.

With this process it is also possible to improve performance by classic, synchronous machines with electrical excitation during grid faults.

It is an advantage if the load is formed by ohmic resistance. The energy that can no longer be supplied to the grid during a voltage dip is then simply converted into heat in the resistor. It is also conceivable, however, to store at least part of this energy in a suitable unit. Possible storage units are any devices that are able to store electrical energy temporarily. Energy storage mechanisms with flywheel, superconducting magnets, or capacitors are mentioned here by way of example.

The load, particularly a resistor, can be either controlled or uncontrolled. A controllable load has the advantage that it can be adapted to the respective voltage dip.

In a favorable embodiment of the invention, part of the electric power that can no longer be supplied to the grid due to the voltage dip is absorbed by an additional, controlled load. This additional load, which is preferably arranged in parallel to the above mentioned load, leads to additional stabilizing of the system.

The phase angle of the generator voltage, for example, can be used as controlled variable for controlling the additional controlled load.

The object of the invention is also an appropriate device for supplying energy to a grid with at least one generator to produce electricity and which is connected to a point of common coupling either via a transformer or directly, where a load, preferably a resistor, which can be shunted out by means of a switch, is provided between the at least one generator and the point of common coupling.

Thus, if there is a voltage dip in the grid, the load can be inserted quickly and easily into the current path. Power that cannot be supplied to the grid can be absorbed by the load and acceleration of the generator rotor is prevented.

It is an advantage if several generators are combined into one module by means of a bus bar, and if the load can be inserted between the bus bar and the point of common coupling.

Thus, a load that can be inserted in between can guarantee stable operation of several generators.

In the following, the invention is described using illustrations. Here,

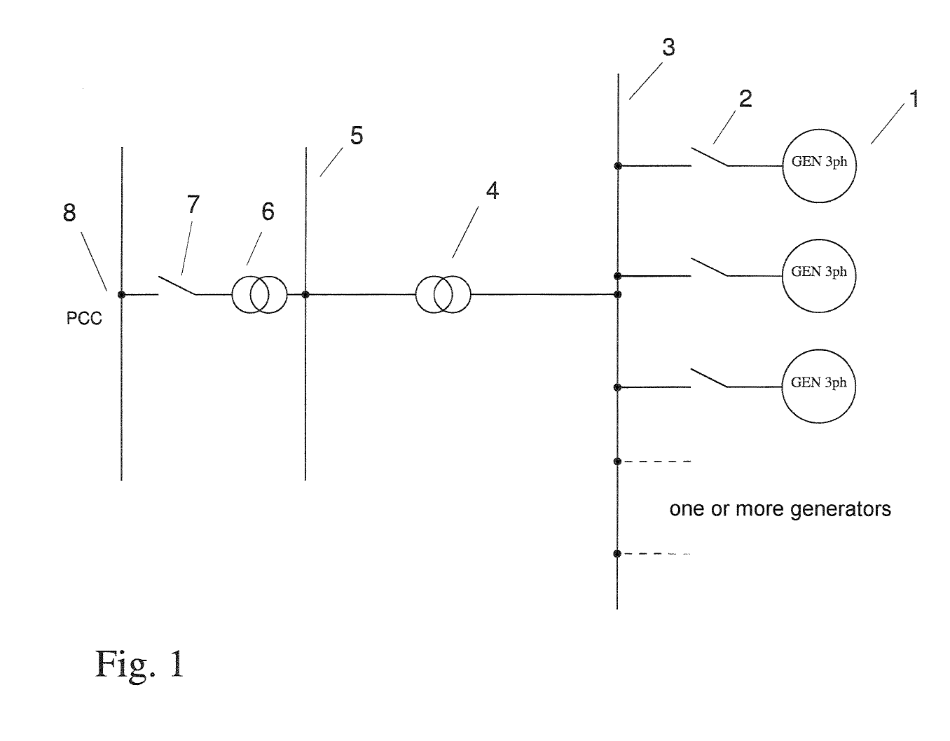

FIG. 1 shows a single-line diagram of a standard configuration according to the state of the art,

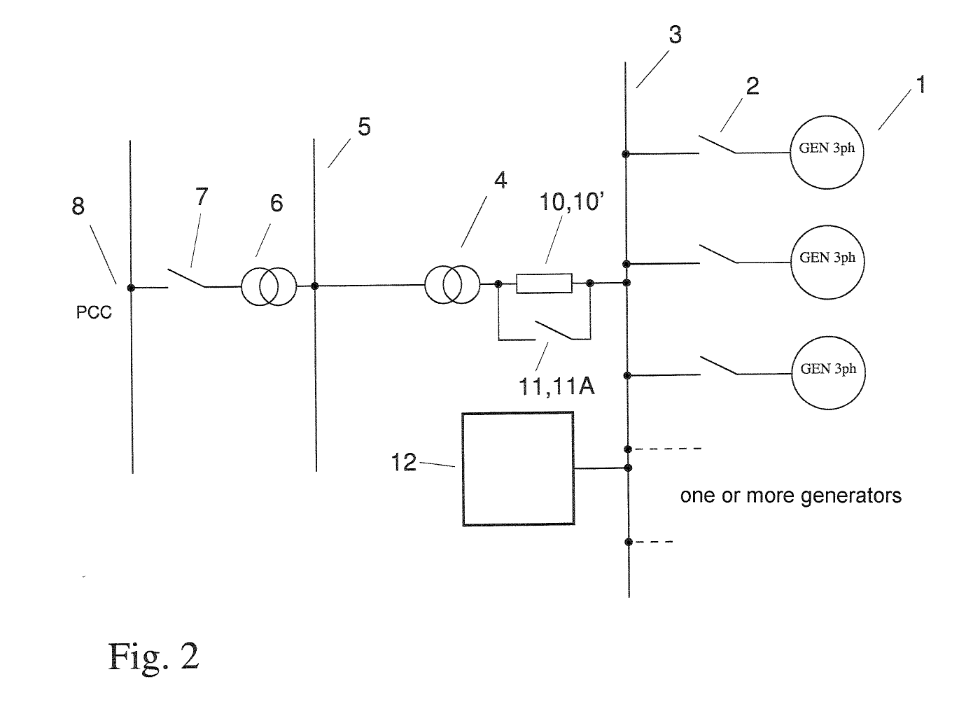

FIG. 2 shows a single-line diagram with the solution according to the invention installed at the voltage level of the generator,

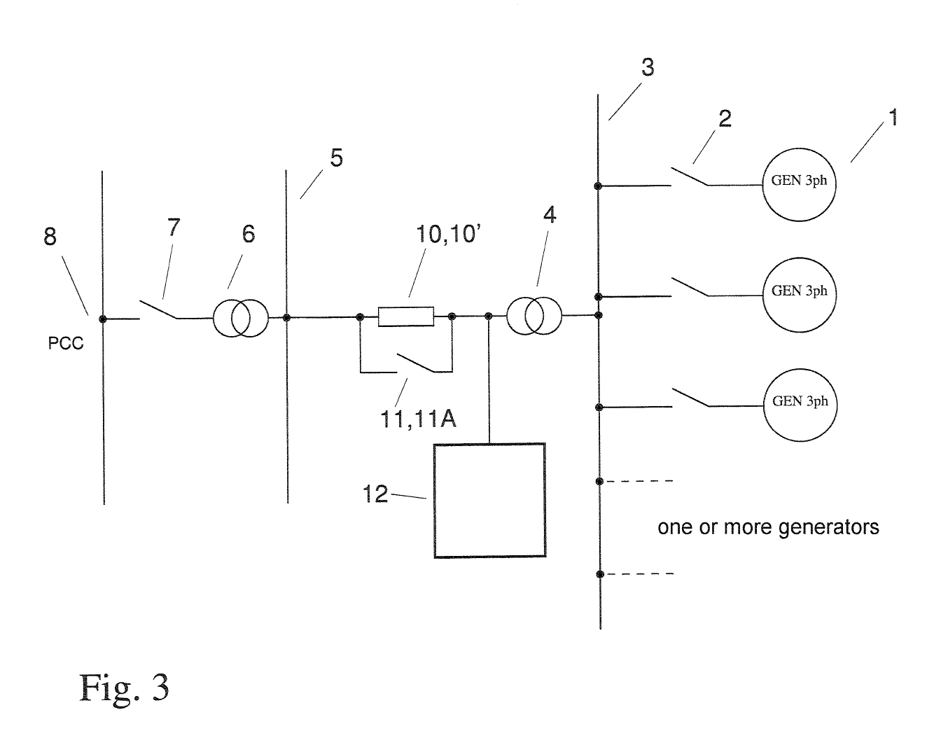

FIG. 3 shows a single-line diagram with a solution according to the invention installed on the transformer higher voltage side,

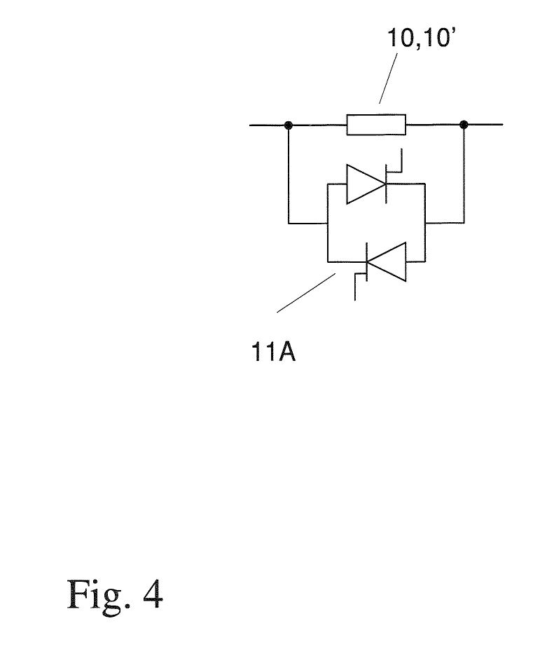

FIG. 4 shows a single-line diagram of an alternative solution for the shunt switch with anti-parallel thyristors,

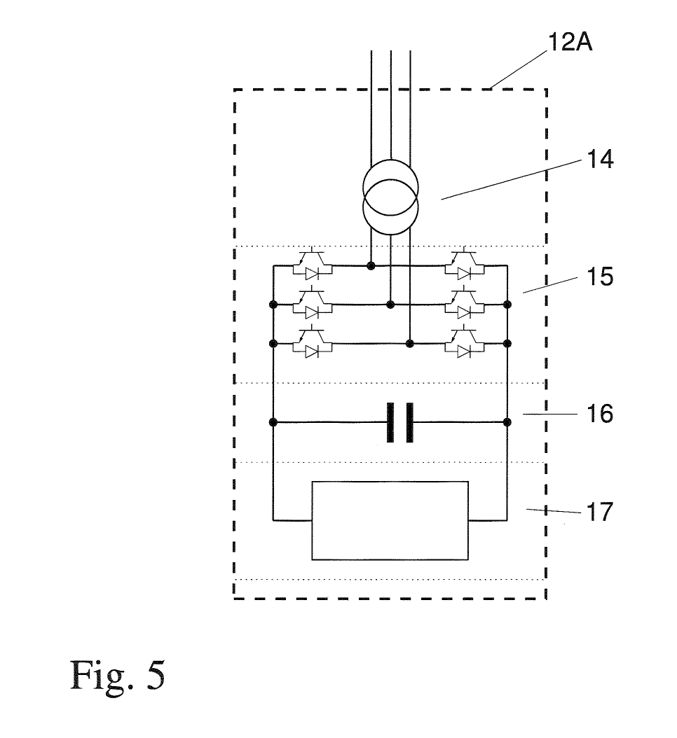

FIG. 5 shows an example of a possible embodiment of a controlled load,

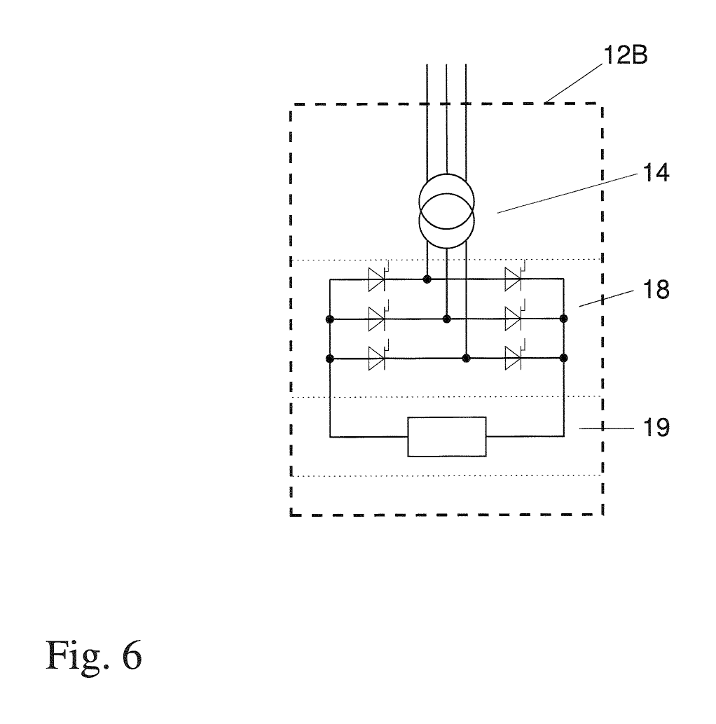

FIG. 6 shows a further example of a possible embodiment of a controlled load,

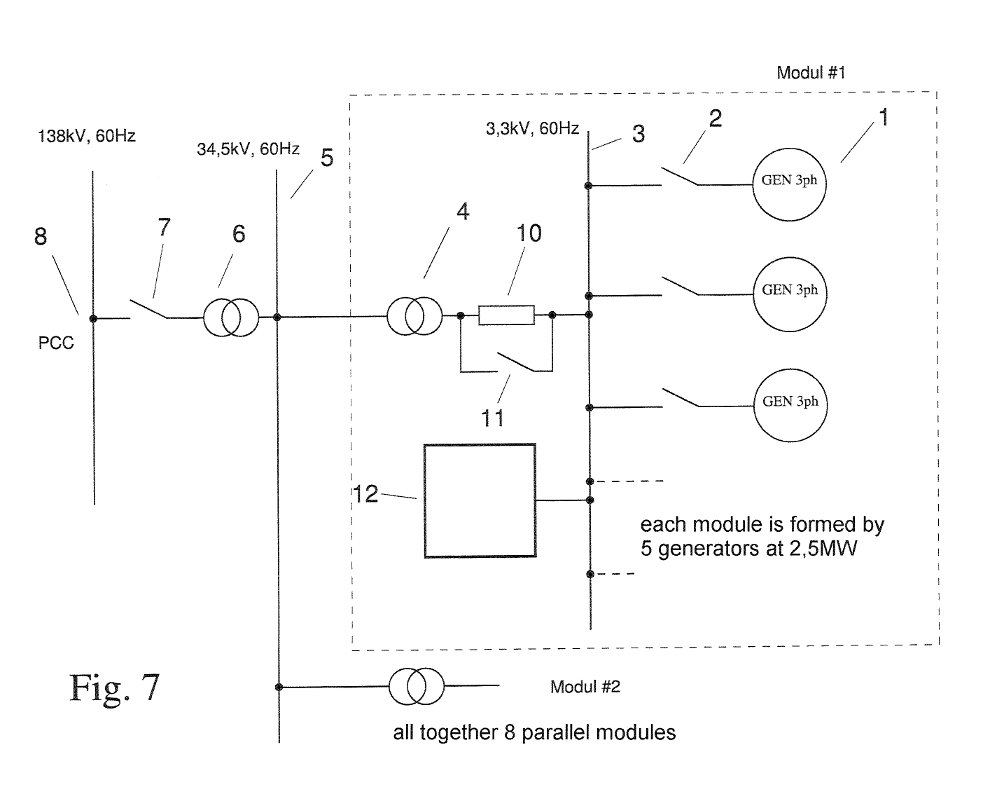

FIG. 7 shows a single-line diagram for the simulation calculations, and

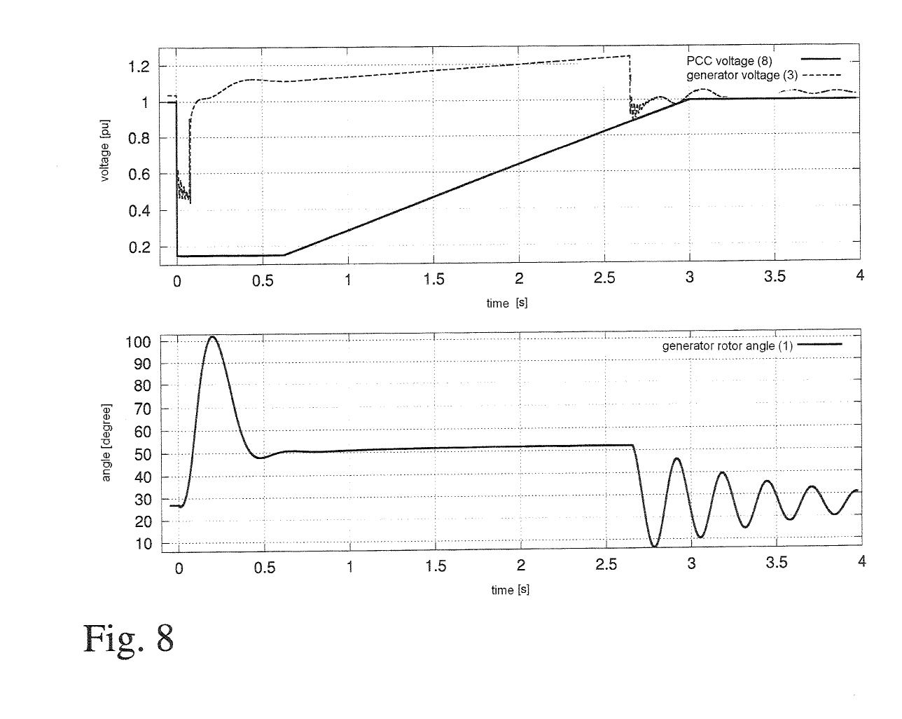

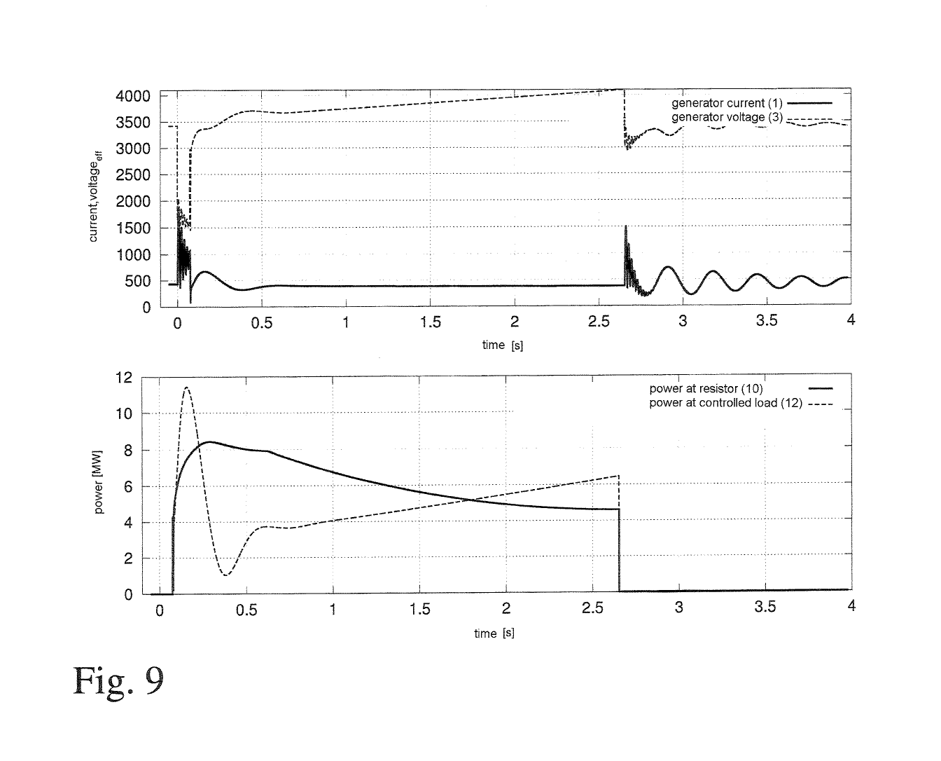

FIGS. 8 and 9 show simulation results.

The same reference numerals in the respective figures refer to the same components.

FIG. 1 shows a schematic diagram of a plant to supply energy to an electric grid. In normal operation of the plant, the energy flows from the generating units, i.e. from the generators 1, via a switch 2 assigned to each unit, to a bus bar 3. Several units can be combined to form modules at this bus bar 3. A transformer 4 for each module is then normally used to transform to medium-voltage level 5. With larger units the energy from the medium-voltage level 5 is transferred via a further transformer 6 and a main circuit-breaker 7 to the power grid. The voltage level here is usually in excess of 100 kV. The point of common coupling 8 is the point at which the contract services between the plant operator and the transmission system operator are defined. Voltages, frequencies, and deviations from these voltages and frequencies are also defined at this point. The point of common coupling 8 is also referred to as the PCC.

Functioning of the plant as shown in FIG. 1 is now described below in detail. In normal operation of the plant, the generator 1 is connected to the grid via a transformer 4 or directly. The power (less losses) generated by the turbines is transferred to the grid via the generators 1.

If there is a grid fault, which may be caused by short circuits or faults to ground, the voltage at the fault dips to virtually zero for the duration of the short circuit. Depending on the location of the fault in the grid, the voltage at the point of common coupling 8 of the unit concerned can dip as far as zero. This means that it is not possible to transfer the power generated by the turbine to the grid in this situation. As a result, the generator 1 is accelerated by the turbine 1 (not shown), which is still providing the same output, and the rotor position of the generator 1 now moves further and further from the position conforming to the initial load status. If this status continues for a certain period, the generator 1 passes the point of no return and can no longer be returned to its original status. The generator 1 must then be disconnected from the grid.

FIG. 2 shows a single-line diagram of the solution according to the invention, which is installed on the voltage level of the generator 1.

The invention is based on a load 10, for example a resistor 10′, being inserted between the generator 1 and the grid for the duration of the dip in voltage.

In normal operation this resistor 10′ is shunted out by a mechanical switch 11 (shunt switch) or an electronic switch 11A. The switch 11, 11A is opened when the grid voltage drops below a certain level, i.e. when a grid fault (voltage dip) is detected at the point of common coupling 8. In this case the switch should be opened with as little delay as possible.

When the voltage at the point of common coupling 8 has returned to a level within the operating range of the plant, the switch 11, 11A is closed again and the plant returns to normal operation.

The resistor 10′ is dimensioned according to the amount of energy to be absorbed. There is no need to dimension it for continuous operation.

Due to the resistor 10′ being dimensioned according to the output of the generators 1, the generator 1 is now able to convert part of the power generated into heat. As a result, acceleration of the generator 1 is avoided and it is possible subsequently to switch back to normal operation. As a non-adjustable resistor 10′ can only be tuned precisely to a load condition, an additional controlled load 12 is provided in FIG. 2. Many different loading devices can be used here, however it is important that the load can be adjusted quickly. In this way, a stabilizing effect can be achieved on the generator 1, for example by adjusting the voltage angle.

The solution according to the invention can also be installed on the higher voltage side of the transformer, as illustrated in FIG. 3.

As an alternative to a mechanical switch 11, FIG. 4 shows an electronic switch 11A with thyristors in anti-parallel arrangement.

The additional controlled load 12 can be designed, for example, as a forced-commutated converter 12A. It consists of a converter transformer 14 for controlled loading, a switched mode converter 15, a DC voltage link 16 with capacitor, and a controlled braking resistor 17 with power electronics and automatic control. This forced-commutated converter 12A is shown in FIG. 5. It is possible to use the forced-commutated converter 12A for static and/or dynamic compensation. This provides an additional benefit from the equipment installed.

FIG. 6 shows a further possible embodiment for an additional, controlled load 12, where this controlled load 12B operates with a load resistor 19 controlled by means of thyristors 18. The controlled load 12B can be dimensioned for short-term operation as it is only active during and for a brief period after the grid fault.

As an alternative to the resistor 10′ inserted, it is also possible to use an energy storage mechanism. As the generator voltage or the voltage on the higher voltage side of the transformer 4 is higher than the reverse blocking voltage of conventional electronic power components, a converter transformer 14 is usually included before the controlled load 12, 12A, 12B.

As control variable for the controlled load 12, 12A, 12B, it is possible to use the phase angle of the generator voltage for example. The set value here is the angle that was measured before the fault occurred. If the actual value of the angle differs from the set value, the output of the additional controlled load 12, 12A, 12B is increased, the machine slows down and can then be switched back to normal operation when the voltage has returned.

All resistors and other components of the set-up according to the invention can be dimensioned for brief operating periods. As a result, the size can be reduced.

In plants with several generators 1, the resistors 10′, switches 11 and controlled loads 12, 12A, 12B can be provided at each generator 1, but it is also possible to combine several generators 1.

The load 10, 10′ can be inserted at any point in the line between the grid and the generating units.

### EXAMPLE

In order to better portray the functioning of the proposed solution, a certain plant configuration was simulated. The circuit diagram of the arrangement selected is shown in FIG. 7. The entire plant consists here of 40 generators 1, which are combined in groups of 5 to form eight modules. The five generators 1 in one module jointly feed a voltage of 3.3 kV and frequency of 60 Hz to the bus bar 3. The generator 1 power is 2.5 MW. In this example, the generators are permanent magnet machines 1. Each module has its own transformer 4 that passes the energy on to the next higher medium-voltage level 5 with 34.5 kV. The eight modules of the plant are combined at this medium-voltage level 5. Then the energy generated by 40 generators 1 is transferred via a further transformer 6 and the respective main circuit-breaker 7 into the grid with 138 kV via the point of common coupling (PCC) 8.

The set-up according to the invention is now inserted between the transformer 4 and the bus bar 3. It comprises a fixed resistor 10′ and a switch 11 for this resistor. In addition, a further controlled load 12 is installed at the bus bar.

The results of the simulation calculation are shown in FIGS. 8 and 9. They also show voltages and currents at the point of common coupling 8 during and after a voltage dip.

The top graph in FIG. 8 shows the voltage progression over time (in per unit system, referring to one generator) at the point of common coupling and at the bus bar 3. The voltage dips to a level of 15% for a period of 625 ms. Then the voltage rises again to the nominal value according to a ramp function. This progression complies with the requirements of a local transmission system operator.

When the voltage dips, the generator voltage also drops to around 50% at first. The voltage does not begin to rise again as a result of the drop in voltage at the resistor 10′ until the switch 11 is opened after a pre-selected delay of 70 ms. When the grid fault has been eliminated (after approx. 2.7 secs) the switch 11 is closed again and the plant returns to normal operation. The bottom graph in FIG. 8 illustrates the corresponding progress over time of the angle of the rotor position in relation to the generator voltage. When a grid fault occurs, the rotor of the generator 1 is accelerated because the power from the turbine can no longer be supplied to the grid. The rotor cannot be moved back close to its initial position until the switch 11 is opened and the controlled load 12 is activated. As a result, it is possible to switch back to the initial status without any great difficulty after a grid fault.

The top graph in FIG. 9 illustrates the current and voltage progression of one of the generators 1 over time. There are only brief peaks, which occur because the set-up proposed can only take effect after a short delay (time to identify the undervoltage and time to open the switch 11).

The bottom graph in FIG. 9 shows the power progression at the resistor 10′ and the controlled load 12. As the facility was installed for a module containing five generators 1, the entire output of the module must be converted in the event of a fault (5×2.5 MW=12.5 MW),

Here the phase angle of the generator voltage before the grid fault was selected as set value of the control variable for the controlled load. The brief power peak in the controlled load 12 arises because the generator 1 accelerates immediately when a fault occurs and then has to be braked again by the load.

When the fault has been eliminated, the effect of the resistor 10′ is de-activated again by closing the switch 11.

The embodiments shown in the drawings only show a preferred embodiment of the invention. The invention can be used for both controlled and uncontrolled generators 1. Uncontrolled generators are generators where neither the real, nor the reactive power is controlled. In controlled generators, the inactive power is controlled by means of generator excitation and the active power by adjusting the turbine, for example.

1. A method for supplying energy to a grid, in which energy in the form of electric current is generated by at least one generator and supplied to the grid, where the generator is either connected directly or via a transformer to a point of common coupling in the grid, where a load, which is shunted out by a switch in normal operation, is inserted by opening the switch, with the result that at least part of the electrical energy that can no longer be supplied to the grid due to a reduced voltage in the grid is absorbed by the load, and wherein a further part of the electric power that can no longer be supplied to the power grid due to the reduced voltage is absorbed by an additional controlled load, and the additional controlled load is not inserted between the generator and the point of common coupling.

2. The method according to claim 1, wherein the switch is closed after the grid reaches a voltage corresponding to normal operation so that the load is shunted out of the grid.

3. The method according to claim 1, wherein the current being generated by the at least one generator includes permanent magnet excitation.

4. The method according to claim 1, wherein the current being generated by the at least one generator is a synchronous machine.

5. The method according to claim 1, wherein the load includes ohmic resistance.

6. The method according to 4 claim 1, wherein the load is formed by an energy storage unit.

7. The method according to claim 1, wherein the part of the electric power that can no longer be supplied to the grid due to the voltage dip is absorbed by a controlled load.

8. The method according to claim 1, wherein a phase angle of the generator voltage is used as control variable for controlling the additional controlled load.

9. A device for supplying energy to a grid with at least one generator to produce electricity and which is connected to a point of common coupling either via a transformer or directly, where a load which can be shunted out by a switch is provided between the at least one generator and the point of common coupling, wherein an additional controlled load is provided through which a part of the electric power that can no longer be supplied to the grid due to the reduced voltage can be absorbed in response to a voltage dip in the grid, where the additional controlled load is not inserted between the generator and the point of common coupling.

10. The device according to claim 9, wherein several generators being combined into one module by means of a bus bar, and by the load being suitable for inserting between the bus bar and the point of common coupling.

11. A method to supply electricity to an electric utility grid comprising:
generating electricity by a generator;
applying the generated electricity to a point of common coupling in the grid;
in response to a voltage in the grid being below a threshold voltage level, actuating a switch to apply the generated electricity to a constant load by wherein the switch is between the generator and the point of common coupling;
in response to a voltage level of the grid being above the threshold level, actuating the switch to shunt the constant load and avoid passing the generated electricity through the constant load, and
applying the generated electricity to a controllable load which is not in an electrical path including the switch or the point of common coupling.
